(19) United States
(12) Patent Application Publication
(10) Pub. No.: US 2016/0089679 A1
(43) Pub. Date: Mar. 31, 2016

(54) AUTOMATED SYSTEM OF FROTH FLOTATION COLUMNS WITH AERATORS INJECTION NOZZLES AND PROCESS THEREOF

(71) Applicant: DPSMS TECNOLOGIA E INOVACAO EM MINERACAO LTDA, Curitiba, Parana (BR)

(72) Inventor: Mauricio Antonio Rodrigues PRESTES, Parana (BR)

(21) Appl. No.: 14/892,339

(22) PCT Filed: May 23, 2013
(86) PCT No.: PCT/IB2013/054252

§ 371 Date: Nov. 19, 2015

(51) Int. Cl. B03D 1/02; B03D 1/14; B03D 1/24

(52) U.S. Cl. CPC B03D 1/028; B03D 1/242; B03D 1/1406

(57) ABSTRACT

An automated system of froth flotation columns is disclosed. Aerators injection nozzles of pulp are vertically positioned at the top of the column for high recovery froth floating of ores such as gold, iron, copper, silver, palladium, platinum and others. In an embodiment, the system includes at least two flotation columns interconnected to each other. The aerators injection nozzles are positioned at the top of the columns and respective flotation process.

### TECHNICAL FIELD

The present invention relates to an automated system of froth flotation columns with aerators injection nozzles and process thereof, for high recovery of ores such as gold, iron, copper, silver, palladium, platinum and others.

### BACKGROUND ART

Among the various technologies in the field of ore dressing, the froth flotation has been the ore concentration process more widely used.

Froth flotation is currently one of the most versatile and an efficient technology used in the field of ore dressing and is used to separate mixtures of different particles in a finely divided state, suspended in a liquid, as described in the patents U.S. Pat. No. 5,902,977 and U.S. Pat. No. 4,441,993.

Its use has allowed the exploitation of minerals in a low level of content and layers of complex mineralogical composition, which otherwise would have been considered without economic value.

For example, in the mining industries, the suspension of solid particles in water is treated with chemical reagents, foaming and/or collectors which has the function of making particles, which wish to remove, water repellent or immiscible in water, while leaving the remaining wet or hydrophilic particles. The process of adding various reactants to the system is known as conditioning.

The liquid which can be a mixture of ore and water, also called as pulp, is fed in a flotation cell which can be in the form of column or tank, where air is injected into, by means of pumps and various devices, in the form of fine bubbles, conventionally externally to the column and by below, but may also be aerated by induced flows in two distinct flows, one beneath and another over. In the process, the hydrophobic particles become bound to the surface of the bubbles which rise through the cell surface, where they can be removed by shovels or transhipment gravitational drag in a collection vessel.

The particles which were not collected by the bubbles remain in suspension and are disposed through the bottom of the cell or column, in the waste. Flotation reagents are added occasionally to aid the formation and stabilization of the foam on top of the liquid in the cell. Clean water can be poured into the foam in order to loosen particles embedded into the bottom of the cell or column.

The flotation process will recover the fine particles suspended in liquids, such as the removal of paint of recyclable paper, especially for the removal of oil and fat particles rejected with water wasted in food industries, for particulate removal in processes for the recovery of contaminated sites; for treating waste of water produced by oil fields, and for recovery of algae and other organisms suspended in fresh water and seawater.

However it should be understood that the same system can be used in processes involving fine particles which are not mineral dispersed in aqueous or not, and floated with gases which are not necessarily air.

In earlier technologies, the flotation process has been held in mechanical cells—as described in the following patent documents CA1080375, U.S. Pat. No. 6,793,079—in which the liquid is agitated by a rotating impeller and the air is introduced in the vicinity of the impeller. The bubble size produced by this device need not necessarily be small, typically having a hysteresis of 1 to 5 mm in diameter.

More recently, the flotation started to be performed on columns, which has advantages for controlling the foaming phenomenon. Flotation columns in use are different in relation of their appearance. Some are high compared to its diameter or width, with a ratio in relation to the height versus diameter of not less than 2×1 even reaching 10×1 or greater.

In this type of device, the pulp injection is typically made of by the bottom of the column—as described in the following patents documents CA2106925, U.S. Pat. No. 7,792,718, U.S. Pat. No. 5,897,772, U.S. Pat. No. 5,431,286, U.S. Pat. No. 4,966,687, U.S. Pat. No. 4,804,460, WO/2011/028736, ZA1996/04970—but may also be done by the top of the column—as described in the patents documents CA02596329, WO93/25313, CA2019790, ZA1987/07238, AP87308467.

The flow of bubbles is generated by a suitable system such as sprays, nozzles, vacuums or bubbles generators by the bottom of the column, above and/or beneath and transversely over the feeding of the pulp as described in the patents documents CA2054620, CA1328316, U.S. Pat. No. 7,163,105, U.S. Pat. No. 6,010,011, U.S. Pat. No. 5,335,785, U.S. Pat. No. 5,307,937, U.S. Pat. No. 5,282,538, U.S. Pat. No. 4,940,534, U.S. Pat. No. 4,735,709, ZA1991/08628. The objective of these systems of airing is to distribute the bubbles evenly through the column. So, the flow of particles carried to the bottom of the column find a uniform cloud of tiny bubbles going toward the top. The individual bubbles collide and capture the ores and products or hydrophobic and carry them to the top of the foam. Several other alternative interpretations of flotation columns are described, for example, in the U.S. Pat. document No. 4,938,865 by Jameson introducing a mixture solution-air in the column where the separation takes place.

### DISCLOSURE OF INVENTION

### Technical Problem

In the products heretofore presented, it can be found several and different problems, but it is the same and common to those using similar processes, that means, the high cost of using forced aeration process, the low performance of the columns in the generation of concentrates, many operations performed manually in the flotation process and the residence time of the floated material when is used conventional flotation cells, as depicted in the patents documents CA2054620, CA2178189, CA1328316, U.S. Pat. No. 7,163,105, U.S. Pat. No. 6,010,011, U.S. Pat. No. 5,335,785, U.S. Pat. No. 5,307,937, U.S. Pat. No. 4,940,534, U.S. Pat. No. 4,735,709, ZA1991/08628, CA02596329, WO93/25313, CA2019790, U.S. Pat. No. 5,814,210, ZA1987/07238, AP87308467, CA2106925, U.S. Pat. No. 7,792,718, U.S. Pat. No. 5,897,772, U.S. Pat. No. 5,431,286, U.S. Pat. No. 4,966,687, U.S. Pat. No. 4,804,460, U.S. Pat. No. 4,592,834, WO/2011/028736, and ZA1996/04970.

Existing products require forced aeration which determines a high cost compared to the present invention, implying use of specific equipments such as air pumps, hoses, internal devices for distribution of compressed air, and, thus they have no automation in the process, all the products have more operations performed manually further increasing the operational cost.

Aeration at enough levels to generate uniform bubbles at a cost economically viable with the ore costs and its content, and, as well as, moreover its recovery cost, are another problems that ultimately may determine levels of recovery and ore concentration of about up to 60% in the products shown previously, which determines losses in the process and, in some cases, with a percentage of concentration up to 80% together with a high residence time up to 72 hours.

For a proper performance of the flotation products presented it is needed that the volume and the aeration system which triggers the formation of air bubbles with a dimension with which it intends to have efficient recovery of desired materials. Besides the variable of feeding associated to the aeration process, it also has the difficulty of managing the process continually that may vary during the processing of a same batch of ore or material to float, which implies the need of more qualified personnel to monitor it as well as more operations performed manually during the process, resulting in levels of recovery of ore below the desired volume and/or possible.

The proposed system brings in its concept three new features that act together to optimize the issue of aeration at optimum levels for the flotation process using at least tow flotation columns with anti turbulence system, with different nozzles combinations and with concept of simultaneous aeration with the column feed the pulp of the ore and/or material with natural aeration, but may be also forced or mechanical, if necessary, together with a proper design of the column and an automated system for process control by controlling variables such as pulp density, volume of foam formed and the level of air contained in the pulp.

The feed of pulp normally is made in the columns, in the state of art, basically in two ways: either underneath of the column associated with an aeration system, or on the top of column, but, laterally, by mean of a namely column diffuser, which is the part of so said as feeding of the column, as depicted in the patents documents CA2054620, CA2178189, CA1328316, U.S. Pat. No. 7,163,105, U.S. Pat. No. 6,010,011, U.S. Pat. No. 5,335,785, U.S. Pat. No. 5,307,937, U.S. Pat. No. 5,282,538, U.S. Pat. No. 4,940,534, U.S. Pat. No. 4,735,709, ZA1991/08628.

Being an extremely clean process, it does not require washing of the foam system—as described in the patents documents CA1210167 and CA1336213, very common in flotation columns, thus reducing further the cost of energy and equipment and water, becoming this system environmentally sustainable. The aeration system designed for these columns is able of a fine process tuning adjustment based on the quality of the material to be processed, increasing the performance of the equipment despite the short residence timing of the pulp within the columns. The system is complemented by an automatic control system of flotation, with control and management of variables such as management of variables such as feeding the column—injection and outlet of pulp—pulp density, volume of foam formed and the level of air contained in the pulp.

### SOLUTION TO PROBLEM

### Technical Solution

To overcome the drawbacks and problems described above and other disadvantages not mentioned herein, in accordance with the purposes of the invention, as described henceforth, one basic aspect of the present invention is directed to an automated system of froth flotation columns with aerators injection nozzles and process, whose elements composing said system interact to each other and they perform the desired final effect, it means, achieving high levels of ore concentrates, in an integrated manner without which said elements could not produce if considered them separately.

### ADVANTAGEOUS EFFECTS OF INVENTION

### Advantageous Effects

An automated system of froth flotation columns with aerators injection nozzles and process provide the following advantages when comparing it to systems already depicted. Higher efficiency in the generation of ore concentrates and/or materials with, surprisingly, up to 96% of recovery of the content of the ores which it seeks to recovers, with an aeration system more effective and cheaper than the existing aeration induced systems in all the aforementioned patents. Moreover, a system with automatic control which reduces operating costs while also reduces human intervention in the process reducing the incidence of errors in the process, and also higher capacity of operation, floating ore in a rate up to 50 ton per hour with lower residence timing of material in the column, up to 3 min per ton of pulp.

Compared it with flotation mechanical cell systems, it has the following differences: for flotation of 150 tons of pulp, the residence timing of the pulp in flotation cells is up to 72 hours versus up to 7 hours in the automated system of froth flotation columns with aerators injection nozzles positioned vertically, object of the present invention. Moreover, the recovery/ore concentration and/or flotation material in the cell is normally up to 60% of the content versus up to 96% recovery/ore concentration performed by the automated system of froth flotation columns with aerators injection nozzles positioned vertically, having the cost for process control significantly less due to the automation.

Compared it with flotation columns systems of the state of art, it has as advantages the recovery/ore concentration and/or material in the flotation columns systems, which is normally up to 80% of the content, versus up to 96% recovery/ore concentration performed by the automated system of froth flotation columns with aerators injection nozzles, the cost for process control is significantly less once it is automated, and the operational cost of the automated system of froth flotation columns with aerators injection nozzles positioned vertically is also significantly less because it uses aeration systems that does not require aeration mechanically induced, either by gas or air, dispensing costs with pumps, hoses, etc. and dispensing their related costs such maintenance and calibration of its equipments.

The system is supplemented by an automatic control of the flotation, control and management of variables such as column feed—injection and outlet of pulp—pulp density, volume of foam formed and the level of air contained in the pulp. The controller of the flotation column regulates the material inflow and outflow, using at least one sensor which identifies the material level in accordance with input parameters, and by using control rules of statistical methods, controls the motor speed of the material inlet and outlet pump seeking balance, the level of material and foam is defined by the sensor in association with the automatic control of the flotation. Regulating the height of the differential pressure sensor it is possible to balance the system above or below the pre-set in accordance with the entry material or initial adjustment of the system, once set the system self-corrects it through the process. The evaluation process of position and correction methods may be, but are not limited to, neural networks, proportional integral derivative controller (PID), feedback controls systems, heuristic methods for error correction or fuzzy logic, and the like.

### BRIEF DESCRIPTION OF DRAWINGS

### Description of Drawings

The above and other exemplary aspects and/or advantages will become more apparent by describing in detail exemplary embodiments with reference to the accompanying drawings, which are not necessarily drawn on scale. In the drawings, some identical or nearly identical components that are illustrated in various figures can be represented by a corresponding numeral. For purposes of clarity, not every component can be labeled in every drawing.

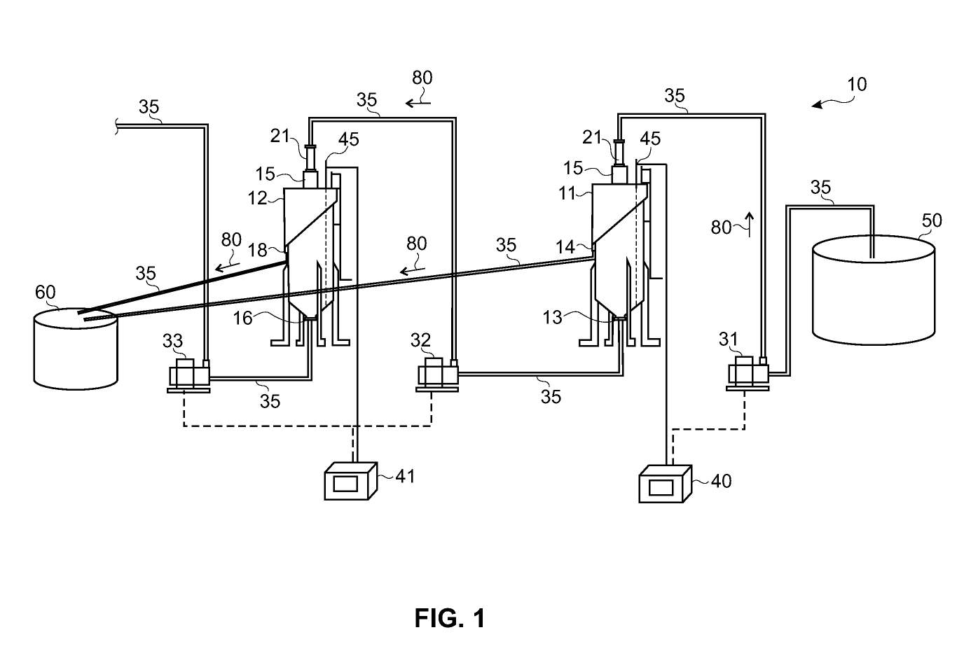

FIG. 1 is a schematic view of an exemplary of an automated system of froth flotation columns with aerators injection nozzles according to an embodiment of the present invention.

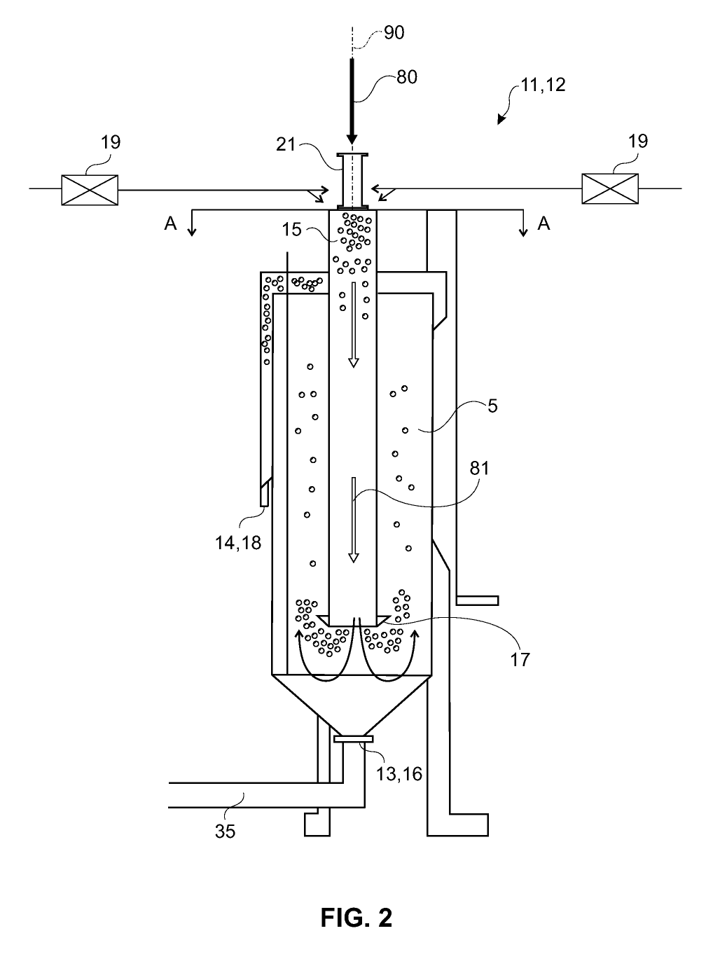

FIG. 2 is a lateral longitudinal sectional view A-A of an exemplary of a froth flotation column with aerators injection nozzles according to an embodiment of the present invention.

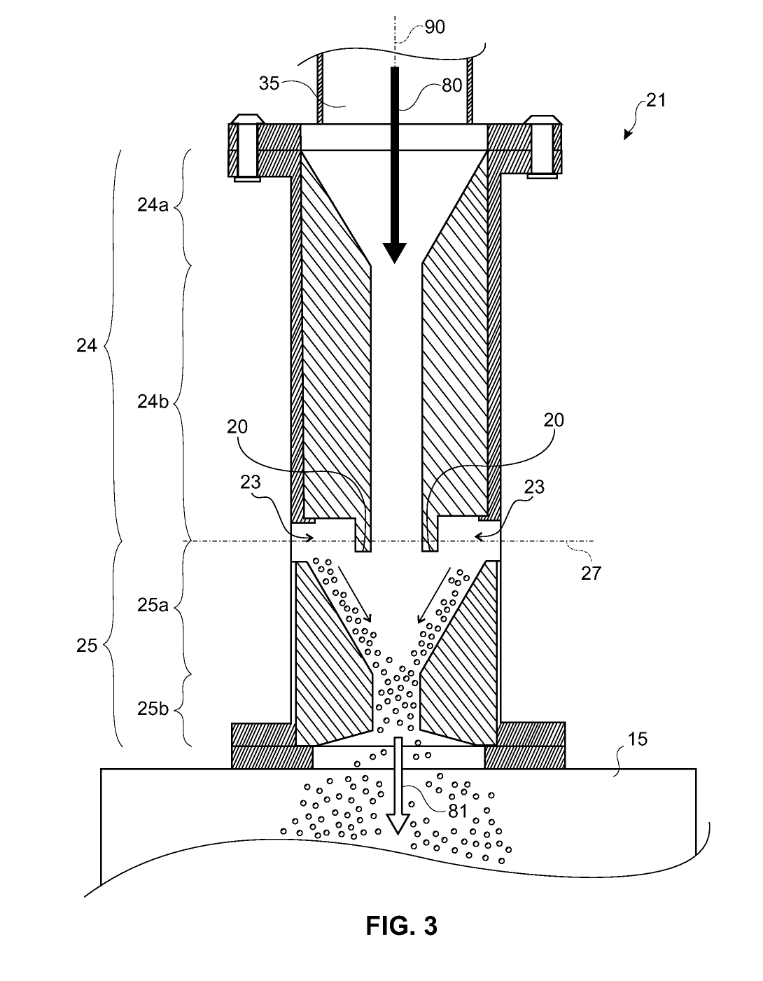

FIG. 3 is a longitudinal sectional view of an exemplary of injection nozzles of pulp according to an of embodiments of the present invention.

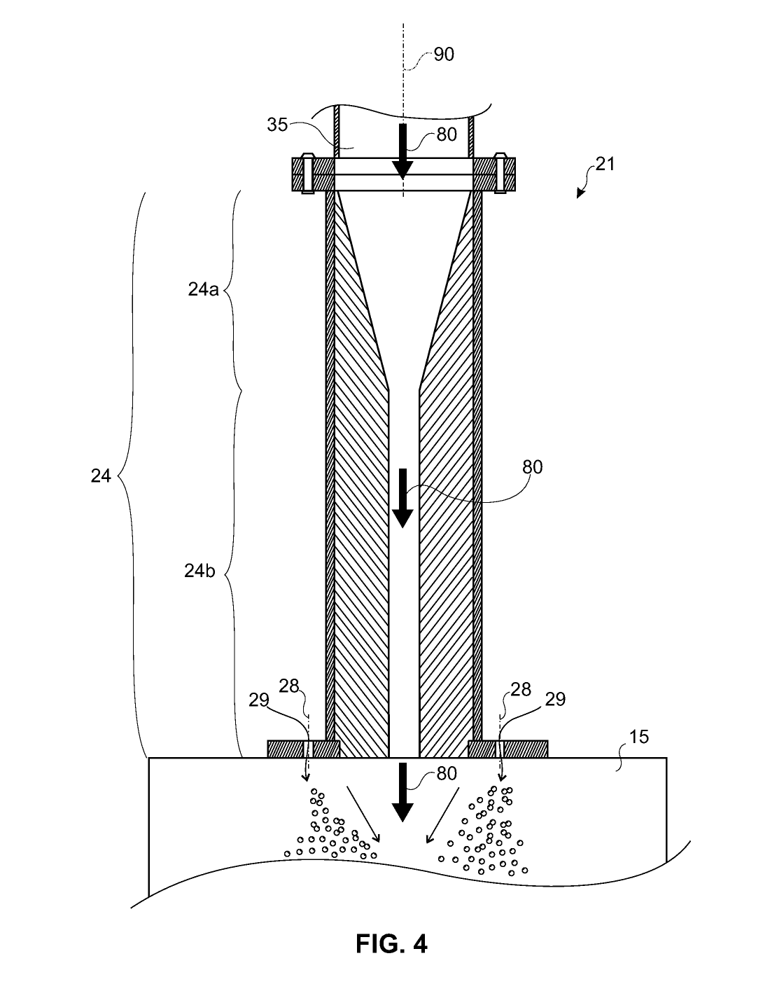

FIG. 4 is a longitudinal sectional view of an exemplary of injection nozzles of pulp according to an embodiment of the present invention.

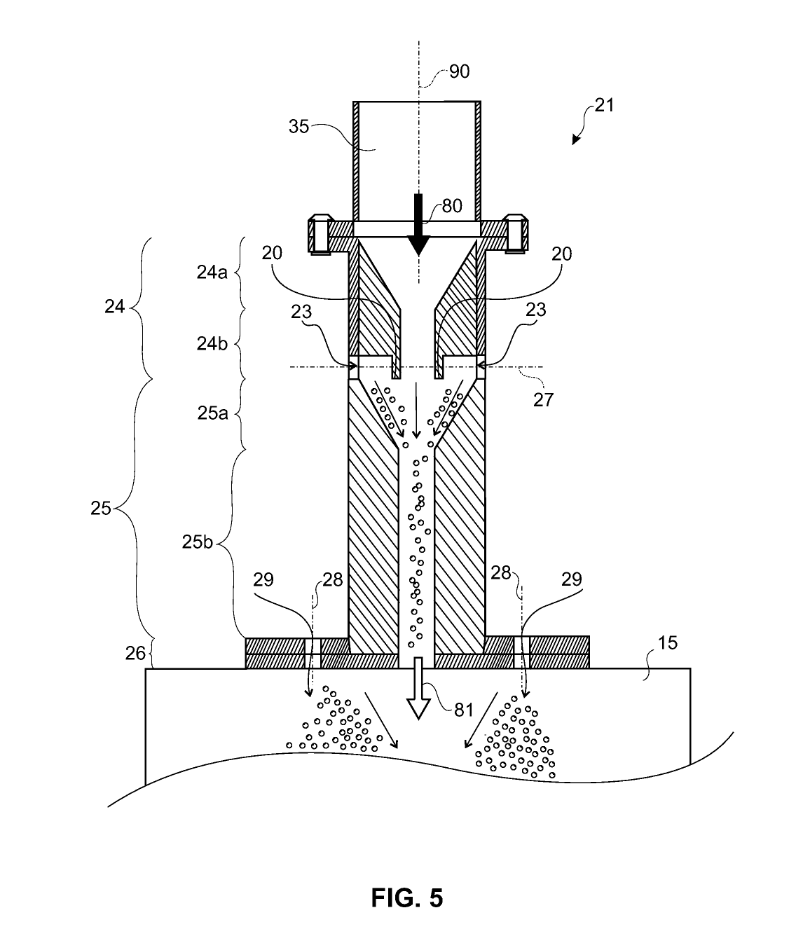

FIG. 5 is a longitudinal sectional view of another exemplary of injection nozzles of pulp according to another embodiment of the present invention.

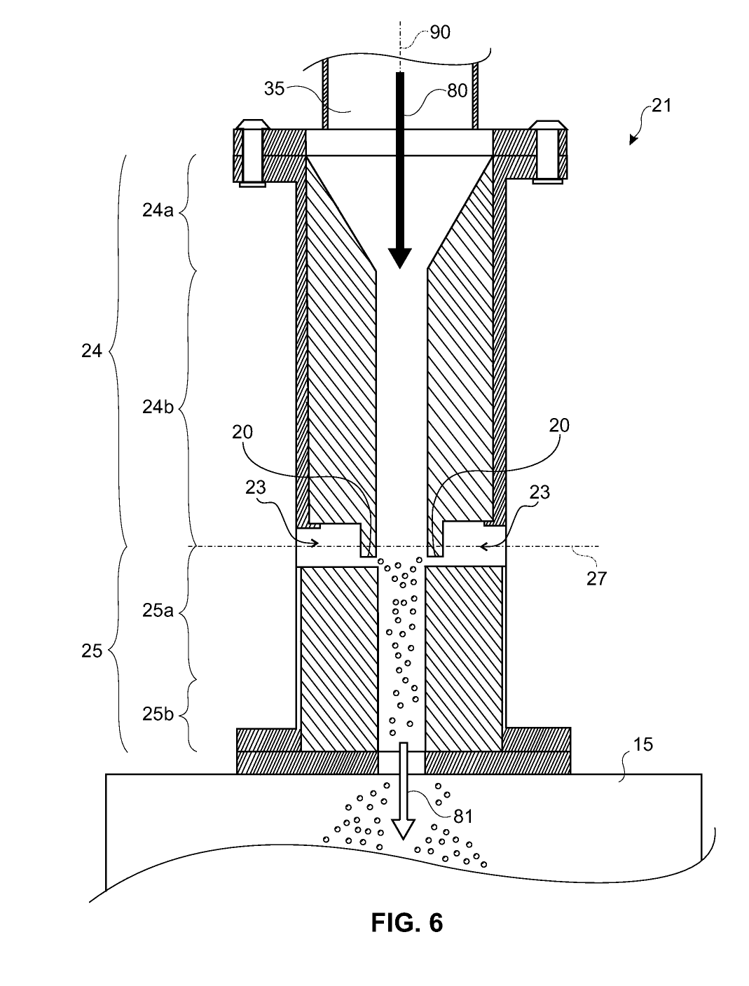

FIG. 6 is a longitudinal sectional view of another exemplary of injection nozzles of pulp according to another embodiment of the present invention.

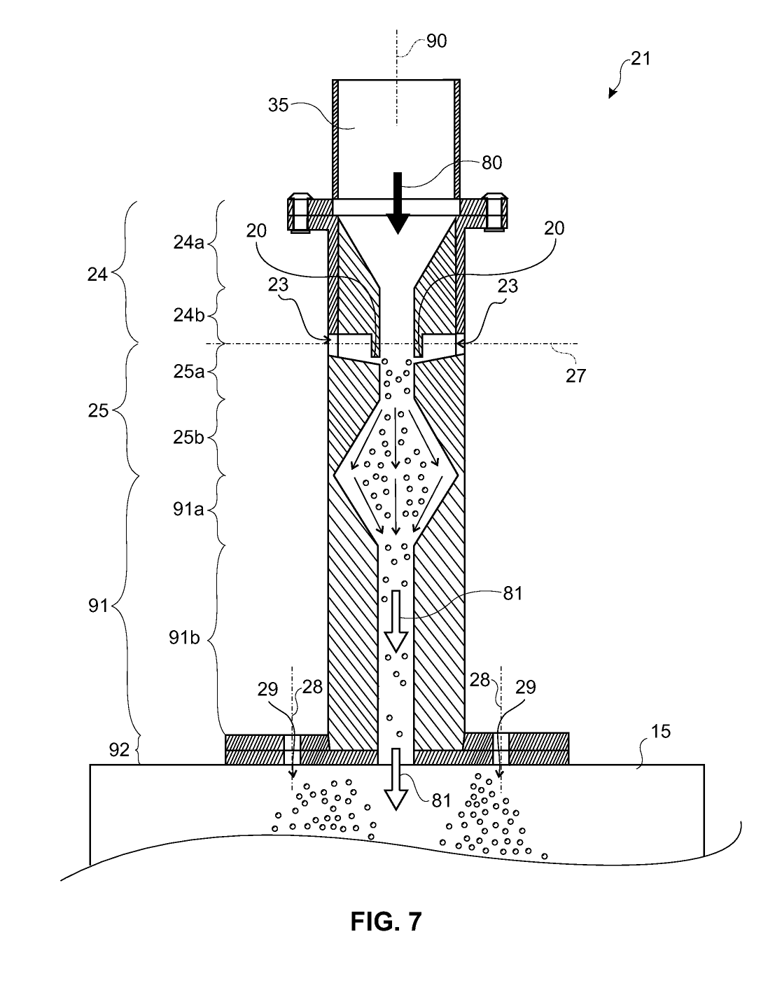

FIG. 7 is a longitudinal sectional view of another exemplary of injection nozzles of pulp according to another embodiment of the present invention.

### NUMERALS EXPLANATION OF NUMERALS

5 Micro Bubbles

10 Automated system of froth flotation columns with aerators injection nozzles.

11 First flotation column

12 Second flotation column

13 Non-floating material outlet of the first flotation column

14 Floating concentrated material outlet of the first flotation column

15 Diffuser

16 Non-floating material outlet of the second flotation column

17 Anti-turbulence device

18 Floating concentrated material outlet of the second flotation column

19 Air control valve

20 Constriction

21 Injection nozzles of pulp

23 Lateral orifices for air intake for the injection nozzles of pulp

24 First stage

24a First portion of the first stage

24b Second portion of the first stage

25 Second stage

25a First portion of the second stage

25b Second portion of the second stage

26 Third stage

27 Central axis of the lateral orifices

28 Central axis of the base orifices

29 Base orifices for air intake for the injection nozzles of pulp

31 First device for transfering of pulp

32 Second device for transfering of pulp

33 Third device for transfering of pulp

35 Element for conducing pulp

40 First controller

41 Second controller

45 Sensor

50 Tank of pulp conditioning

60 Tank of concentrates

80 Pulp flow and/or concentrates flow

81 Pulp flow with air bubbles

90 Longitudinal central axis of flotation column

91 Third stage

91a First portion of the third stage

91b Second portion of the third stage

92 Forth stage

### MODE FOR THE INVENTION

### Mode for Invention

Hereinafter, exemplary embodiments will be described with reference to the attached drawings. Like reference numerals in the drawings denote like elements. While exemplary embodiments are described herein, they should not be construed as being limited to the specific descriptions set forth herein; rather, these embodiments are provided so that this disclosure will be thorough and complete. In the drawings, the sizes of components may be modified for purposes of clarity.

The phraseology and terminology used herein is for the purpose of description and should not be regarded as limiting. The use of ‘including’, ‘comprising’, ‘having’, ‘containing’ or ‘involving’, and variations thereof used in this description, is meant to encompass the items listed thereafter and equivalents thereof as well as additional items. The dimensions as recited herein are merely exemplary and other dimensions may be used in conjunction with the exemplary embodiments as would be understood by one of skill in the art.

Likewise the machine elements which correspond to basic mechanical parts and aspects commonly used in the art, most which are standardized to common sizes, such as frames members, bearings, axis, fasteners, seals, etc. are means not shown, but which should not be construed as limiting as being limited to the invention.

FIG. 1 illustrates schematically an example of an automated system of froth flotation column with nozzles aerators according to an embodiment of the present invention. The interconnection distance between the elements composing said automated system of froth flotation columns with aerators injection nozzles 10, such as at least: a first flotation column 11, a second flotation column 12, a transfer pulp device 31, a second transfer pulp device 32, a third transfer pulp device 33, a tank of pulp conditioning 50, a tank of concentrates 60 as well as a first controller 40 and second controller 41, and others, is merely illustrative and is intended primarily of showing clearly the interconnections and interactions between the elements of said automated system of froth flotation columns with aerators injection nozzles 10, without, however, limiting the constructive configuration of the system, which may be, for example, in a way compact or dense wherein the components comprised in said automated system of froth flotation columns with aerators injection nozzles 10 are set very next to one another so as to optimize the space allocated to the installation area. Said automated system of froth flotation columns with aerators injection nozzles 10 with nozzles aerators preferably comprises the use of at least two flotation columns connected to each other, preferably in series, however, additional columns (not shown) may be used if necessary for faster processing of the material volume to be floated as well as can be connected in parallel, according to aspects of interconnection and interaction between each element which compose it. For example, in the case of adding flotation columns in series to the automated system of froth flotation columns with aerators injection nozzles 10, the sets of connection links shown in FIG. 1 may be represented by the equation

$${S}_{n} = [ {\sum }_{i = 1}^{n - 1} {C}_{i} {F}_{i} {B}_{i} ] + {C}_{n} {F}_{n} {B}_{n} {B}_{n - 1} \qquad [ Math . 1 ]$$

where S corresponds to the automated system of froth flotation columns with aerators injection nozzles 10, ‘n’ is the number of elements of the system in terms of F (flotation columns) varying in ‘i’ or ‘n’ for C (controllers) and/or B (devices for transferring of pulp) and wherein

{n∈N|n≠0} [Math.2]

; and, C.F.B and/or C.F.B.B are the subsets of elements in some connection relation to the respective controllers within the system S.

As depicted in FIG. 1, the transfer pulp device 31, 32, 33, etc. is preferably a motor pump, more preferably for transporting pulp which involves liquid and/or air entrained pulp or slurries, such as froth pulp and/or abrasive pulp, which can be horizontal or vertical pumps, such as, for example, metering pumps, which may be electronic, piston and diaphragm with pneumatic actuator, according to the requirements of hydraulic transport of automated system of froth flotation columns with aerators injection nozzles according to an embodiment of the present invention.

The elements of conducting pulp 35 are preferably hoses designed for transfer pulp devices in accordance with an embodiment of the present invention, which can be other appropriate means of handling materials in hydraulic or pneumatic systems for transporting of pulp, preferably elastomeric material, for example, rubber, to increase strength and reduce the deformations, cracks and vibrations due to the equipment itself and the conveyed material, as schematically depicted in FIG. 1.

The elements for conduction pulp 35, as shown in FIG. 1, are exemplary, suitable for concentrated material, material after flotation, for non-floating material, or partially floated, but may vary depending on the necessity imposed by the composition of the material to be transported.

The tank of pulp conditioning 50, shown in FIG. 1 as well as the tank of concentrates 60 may be standard tanks usually employed in systems involving flotation processes.

In accordance with FIG. 1 the connections of the controllers with said automated system of froth flotation columns with aerators injection nozzles 10 are represented by solid lines for direct connection of information, and dotted lines in relation to the feedback of information. At least a first controller 40 is connected to a device for transferring pulp 31 as well as a sensor 45 according to an exemplary embodiment of the present invention.

Furthermore, the system comprises at least a second controller 41 which is connected to a second device for transferring pulp 32, for feedback of information, also to a third device for transferring pulp 33, for feedback of pieces of information, and directly to a sensor 45.

This order of arrangement can be repeated successively, in the event that the requirements for production capacity or volume of materials to be processed, be need to install supplementary flotation columns to the base system, according to an exemplary embodiment of the present invention. The controllers mentioned above are meant to keep the system in conditions operationally stable, for this reason it uses an specific configuration of connections that enable an automatic adjustment of the control parameters. Said controllers can be digital, or various types of programmable logic control using rules and statistical methods such as neural networks, proportional integral derivative controller (PID), feedback controls systems, heuristic methods for error correction, fuzzy logic or similar.

The sensor 45, mounted in the columns by means not shown, as schematically depicted in FIG. 1, is preferably a differential pressure sensor used to measure material level such as pulp and foaming by comparing the pressure above and below the liquid or positioning of the differential pressure sensor. For effective operation of a flotation column, such as at least the flotation columns 11 and 12 of the present invention, the level must be controlled near a pre-specified level, or input parameter, so that the froth height is not so low, that the significant mixing that occurs in the froth phase results in a loss in grade, and not too high, resulting both in an excessive residence time of bubbles in the froth phase and a loss of residence time in the pulp phase, which affects the result by losing of recovery.

In order to enable the measurement of the size of the micro bubbles 5 generated by the flotation process, the sensor 45 of the flotation columns can be configured with at least one infrared sensor, or alternatively, may be configured with an ultrasound sensor, mounted in the columns by means not shown. As one skilled in the art will recognize, an ultrasound sensor measures the micro bubble 5 size by the interaction between the ultrasonic wave and the suspended particles, e.g., transmission, reflection, absorption and scattering, considering the velocity at which an ultrasonic wave propagates through a particulate suspension, like as a pulp flow with air bubbles 81.

The infrared sensor, in turn, measures the size of micro bubbles 5 by considering the characteristic of the material or foam in terms of light transmission, reflection, or refraction, as one skilled in the art will recognize. For the present invention, the infrared sensor can be used for level detection by contact or without contact with the fluid. Particularly, these infrared sensors can also be used to detect the levels of specific materials or foam, and can be used to determine whether foam or material reached a specific viscosity, density, opacity, or condition of thermal conductivity.

FIG. 2 illustrates a lateral longitudinal sectional view a side view of an exemplary of a froth flotation column with aerators injection nozzles according to an embodiment of the present invention wherein a injection nozzle of pulp 21 is positioned substantially at the center of the diffuser 15 top and substantially in line with the longitudinal central axis 90 of each flotation column 11 and/or 12 and connected by respective bases of said nozzles, by means not shown, at the upper end of each respective diffuser 15.

The flotation columns 11 or 12 utilized in said automated system of froth flotation columns with aerators injection nozzles 10 are configured with injection nozzles of pulp preferably distinct from each other according to different combinations of embodiment of the injection nozzles in the present invention as designed shown in FIG. 3 to FIG. 7, and preferably but not necessarily having the first flotation column 11 with an injection nozzle of pulp in two-stage with a first portion 25a cone-shaped tapered in the direction of pulp flow 80, according to an embodiment of the injection nozzle of pulp in the present invention, as shown specifically in FIG. 3, and the second flotation column 12 with an injection nozzle of pulp in a single-stage, also according to an embodiment of the injection nozzle of pulp in the present invention, as depicted in FIG. 4. In a more preferred embodiment of the automated system of froth flotation columns with aerators injection nozzles 10, the injection nozzle of pulp 21 used in the second flotation column 12, that means, in a single-stage as shown in FIG. 4, accelerates the pulp in higher intensity into the diffuser 15 than the injection nozzle of pulp 21 used in the first flotation column 11, that means, in two-stages, as shown in FIG. 3. Also, the injection nozzle of pulp in a single-stage decelerates the pulp during the injection process, more abruptly than the injection nozzle of pulp in two-stages, making much greater turbulence in the second flotation column 12 than in the first flotation column 11, generating a negative pressure which is this time parallel to the feed of pulp in the second flotation column 12, and consequently reusing the materials that has not been collected by the micro bubbles 5 originated for flotation from the first flotation column 11, thus complementing the generation of concentrated material in the tank of concentrates 60. Accordingly, the interaction between at least two flotation columns as well as different combining in the use of injection nozzles along the system, according to the designs shown in FIG. 3 to FIG. 7, promotes better and higher recovery of material along the system, for example: the flotation column 11 can use an injection nozzles of pulp 21 as design in FIG. 3, and the flotation column 12 can use an injection nozzles of pulp 21 as designed in FIG. 4, bringing distinct designs of injection nozzles of pulp 21, to the same automated system of froth flotation columns with aerators injection nozzles 10.

However, the flotation columns 11 or 12 can also use identical injection nozzles of pulp 21, if suitable according to the production requirements, for example: the flotation column 11 can use an injection injection nozzles of pulp 21 as design in FIG. 3, and the flotation column 12 can use the same one, it means, an injection nozzles of pulp 21 as designed in FIG. 3, too.

As schematically shown in FIG. 2, additionally, injection injection nozzles of pulp 21 provided in flotation columns 11 or 12 can be configured with valves, in accordance with an embodiment of the present invention. Such valves can be either mechanical or electronic, for example and not limited to, a piloted non-return valve which suitable for short-duration positioning and braking functions in pneumatic drives wherein air flows to and from the drive as long as a pilot signal is applied to a pneumatic connection. If no pilot signal is applied, the valve shuts off the exhaust air from the drive in flow direction and the movement of the drive is stopped. Since the injection nozzles of pulp 21 preferably utilize the Venturi concept, aeration can be controlled and supplied through valves installed in each orifices for air intake according to the quantity of orifices for air intake for the injection nozzles of pulp—according to various embodiments of injection nozzles of pulp 21—in interaction with the present invention as whole, particularly with controllers 40 or 41. Each of the valves with the individual dimension of about 8 mm in diameter has control of air volume being released into the column, allowing to control and to adjustment of the air depending on the type of material being processed.

FIG. 2 also schematically shows the diffuser 15 and the anti-turbulence device 17. The diffuser 15 is mounted, by means not shown, into and essentially co-axially with the central longitudinal axis of each flotation column 11 or 12. The diameter of the diffuser 15 is larger than the diameter of the injection nozzle of pulp 21 and smaller than the vessel/recipient diameter of own flotation column 11 or 12, causing a sudden or gradual change of area section according to the possible embodiments of the injection nozzle of pulp 21, in the same direction of pulp flow with air bubbles 81. The diffuser 15 extends in length substantially to the bottom of the column flotation vessel/recipient through which the pulp-air mixture reaches the bottom, in an inverted cone-shaped—with the lower section of the cone down, of the flotation column 11 or 12, allowing the microbubbles 5, generated after the turbulence afforded by the shock of the mixture against the bottom, rise then to the top of the column, by the outside of the diffuser 15 generating a foam layer which brings—by the mechanism of surface tension—hydrophobic materials which are the materials seek to recover through this process by using this system.

The anti-turbulence device 17 is mounted, by means not shown, in the lowermost end of the diffuser 15. Such anti-turbulence device 17 is shaped in circular periphery with a downward tapering conical frustum skirt, or in the format of a truncated hollow cone with its larger base facing upward, and wherein the inner diameter of the bottom peripheral portion is identical to the internal diameter of said diffuser 15, while being concentric to the longitudinal central axis 90 of each respective flotation column. The diffuser 15 is encompassed by said downward tapering conical frustum skirt, or from a lowermost circular rim to the uppermost circular rim, as depicted in FIG. 2.

As improvement in recovery is due in part to the increase in the number and surface area of the micro-bubbles 5, an excessive increase of flow may cause turbulence or frothing in the recovery zone, negatively affecting the performance of flotation.

The vessel of a flotation column 11 or 12 has its lowermost portion shaped conically tapered towards the non-floating outlet material 13 or 16. This shape is suitable to collect the non-floating material, by easily driving the flow through it due to its section variation, as depicted in FIG. 2.

FIG. 3 illustrates a longitudinal sectional view of an exemplary of injection nozzle of pulp according to an of embodiments of the present invention formed by so-called herein, two-stages. The injection nozzle in two-stages preferably comprises in an integrated manner, so called in the present invention, a first stage 24 and a second stage 25. The first stage is on the other hand subdivided by, so called, a first portion of the first stage 24a and a second portion of the first stage 24b. The second stage is in turn subdivided by so called in the present invention, a first portion of the second stage 25a and a second portion of the second stage 25b. Specific configurations of such portions and stages serve to achieve the desired effect, integrated into the system, in terms of recovery performance by concentrating ores or other material that is processed in said automated system of froth flotation columns with aerators injection nozzles 10. The first stage 24 comprises a first portion 24a cone-shaped tapered in the direction of pulp flow 80 and positioned at the entrance of the flow of pulp 80 of the respective injection nozzle of pulp 21. One skilled in the art will recognize that the first portion 24a serves to direct the pulp to the second portion 24b while increasing its velocity and reducing the pressure, being tapered to reduce turbulence. A second portion 24b in a cylindrical shape with a diameter equal to the lower end of said tapered cone of the first portion 24a, and having one end of constriction 20, is used to perform the acceleration of the pulp flow 80 and consequent reduction of pressure at the end of the lower end of said second portion 24b in relation to the exterior pressure to said injection nozzle of pulp 21, according to the Venturi principle. A second stage 25 comprises a first portion 25a also cone-shaped tapered in the direction of pulp flow 80 and positioned at the exit of the pulp flow 80 of said first stage 24 where it is substantially held the mixture of pulp with air by the Venturi principle due to the reduction in pressure reached at the end of the lower end of said second portion 24b of the first stage 24. Having a second stage 25 also cone-shaped tapered in the direction of the pulp flow 80, it allow, beyond the space to perform the mixture of air and pulp, to reduce sharp contact between air and pulp while drives the pulp more smooth to the entrance of the diffuser 15, once deflections of the flow create friction, and consequently changing pressure losses and the performance, in terms of increase or decrease. Additionally, at least four air intake lateral holes 23 are arranged equidistantly on the side, the same height and around of said injection nozzle of pulp 21, integrated substantially between said first stage 24 and said second stage 25, where said sided holes 23 have their central axis 27 of the lateral orifices substantially perpendicular to the central longitudinal axis 90 of the respective flotation columns 11, 12 and the pulp flow 80, and they connect the said injection nozzle of pulp to the outside for aeration of the pulp flow 80 by the Venturi principle. Such constructive aspect of the injection nozzle of pulp in two-stages allows the performance of the automated system of froth flotation columns with aerators injection nozzles 10, as a whole and in interaction with other components of the present invention, is greater than would be achieved if its use would made with conventional Venturis.

FIG. 4 illustrates a longitudinal sectional view of another exemplary of injection nozzles of pulp according to another embodiment of the present invention formed by so-called herein, a single-stage. The single-stage 24 comprises a first portion 24a cone-shaped tapered in the direction of pulp flow 80 and positioned at the entrance of the pulp flow 80 of the respective injection nozzle of pulp 21, and a second portion 24b in a cylindrical shape with a diameter equal to the lower end of said tapered cone of the first portion 24a. Furthermore, it comprises at least four air intake holes 29 arranged equidistantly around on the basis of said injection nozzle of pulp 21, substantially integrated between said single-stage 24 and respective diffuser 15 of respective flotation column, being said holes 29 having their axis of the base orifices 28 substantially parallel to the central longitudinal axis 90 of the respective flotation column and to the pulp flow 80, they connect the said injection nozzle to the exterior for aeration of the pulp flow 80 by the Venturi principle. Having a single-stage 24 and base orifices for air intake for the injection nozzles of pulp 29 arranged in the base, rather than by side of said injection nozzle of pulp 21, it performs a pulp-air mixture in a more abrupt way, and greater than performed, for example, in a flotation column that uses a nozzle in two-stages, according to an embodiment of the present invention. Such constructive aspect of the injection nozzle of pulp in a single-stage allows the performance of the automated system of froth flotation columns with aerators injection nozzles 10, as a whole and in interaction with other components of the present invention, to be greater than would be achieved if its use would made with conventional Venturis.

FIG. 5 illustrates longitudinal sectional view of another exemplary of injection nozzles of pulp according to another embodiment of the present invention formed by so-called herein, three-stages. A first stage 24 comprises a first portion 24a cone-shaped tapered in the direction of pulp flow 80 and positioned at the entrance of the pulp flow 80 of the respective injection nozzle of pulp 21, and a second portion 24b in a cylindrical shape with a diameter equal to the lower end of said tapered cone of the first portion 24a, and having one end of constriction 20. A second stage 25 comprises a first portion 25a also cone-shaped tapered in the direction of pulp flow 80 and positioned at the exit of the pulp flow 80 of said first stage 24, where it is held substantially a first mixture of the pulp with air by the Venturi principle. At least four air intake sided holes 23 equidistantly arranged on the side, at same height and around of said injection nozzle of pulp 21, integrated substantially between said first stage 24 and said second stage 25, where said holes 23 have their central axis of the lateral orifices 27 substantially perpendicular to the central longitudinal axis 90 of the respective flotation column and to the pulp flow 80, and they connect said injection nozzle of pulp to the exterior for aeration of the pulp flow 80 by the Venturi principle. A third stage 26 comprises a set of at least four air intake holes 29 arranged equidistantly around on the basis of said injection nozzle of pulp 21, integrated substantially between said second stage 25 and the diffuser 15 of their respective column flotation, being said holes 24 having their central axis of the base orifices 28 substantially parallel to the central longitudinal axis 90 in relation to the respective flotation column and to the pulp flow 80, and they connect said injection nozzle of pulp to the exterior for aeration of the pulp flow 80 where is substantially performed the second mixture of the pulp with air by the Venturi principle. Having three-stages 24, 25 and 26 and air inlet holes 29 arranged in the base and simultaneously also on the side of said injection nozzle 21, it performs a mixture of air and pulp which generates micro bubbles 5 and increases surfaces tension to collecting hydrophobic material. Such constructive aspect of the injection nozzle of pulp in three-stages allows the performance of the automated system of froth flotation columns with aerators injection nozzles 10, as a whole and in interaction with other components of the present invention, to be greater than would be achieved if its use would made with conventional Venturis.

FIG. 6 illustrates a longitudinal sectional view of another injection nozzle pulp according to another embodiment of the present invention formed by so-called herein, two-stages-straight. A first stage 24 comprises a first portion 24a cone-shaped tapered in the direction of pulp flow 80 and positioned at the entrance of the pulp flow 80 of the respective injection nozzle of pulp 21, and a second portion 24b in a cylindrical shape with a diameter identical to the lower end of said tapered cone of the first portion 24a, and having one end of constriction 20. A second stage 25 comprises a first portion 25a in a straight format in the direction of pulp flow 80 and positioned at the exit of the pulp flow 80 of said first stage 24 where it is held substantially a first mixture of the pulp with air by the Venturi principle.

The constriction 20 that is placed at the end of the second portion 24b causes also drop in pressure as air flows throught it by the air intake holes 23, consisting essentially of a short throat between different sections used to increase velocity of the air into the main flow stream, in the same way the constriction, represented by the portion 24b provides to the pulp flow 80 along it. The design, as depicted in FIG. 6, can be considered as if they were two Venturis perpendicularly crossed, to provide a preliminary Venturi effect for the pulp flow 80 and one preliminary Venturi effect to the air, before and adjacent to the point of mixture pulp-air. At least four air intake holes 23 equidistantly arranged on the side, at same height and around of said injection nozzle of pulp 21, substantially integrated between said first stage 24 and said second stage 25, where said holes 23 have their central axis of the lateral orifices 27 substantially perpendicular in relation to the central longitudinal axis 90 of the respective flotation column and pulp flow 80, they connect the said injection nozzle to the exterior for aeration of the pulp flow 80 by the Venturi principle. Having two-stages-straight 24 and 25 and lateral orifices for air intake for the injection nozzles of pulp 23 it performs a mixture of air and pulp which generates micro bubbles 5 and increases surfaces tension to collecting hydrophobic material. Such constructive aspect of the injection nozzle of pulp in two-stages-straight allows the performance of the automated system of froth flotation columns with aerators injection nozzles 10, as a whole and in interaction with other components of the present invention, to be greater than would be achieved if its use would made with conventional Venturis.

FIG. 7 illustrates a longitudinal sectional view of another exemplary of injection nozzles of pulp according to another embodiment of the present invention, formed by so-called herein, four-stages. A first stage 24 comprises a first portion 24a cone-shaped tapered in the direction of pulp flow 80 and positioned at the entrance of the pulp flow 80 of the respective injection nozzle of pulp 21, and a second portion 24b in a cylindrical shape with a diameter identical to the lower end of said tapered cone of the first portion 24a, and having one end of constriction 20. A second stage 25 comprises a first portion 25a cylindrically shaped with a diameter identical to the lower end of said tapered cone of the first portion 24a, and a second portion 25b cone-shaped tapered in the opposite direction to the pulp flow 80. Additionally, at least four air intake holes 23 are arranged equidistantly on the side, at same height and around of said injection nozzle 21, integrated substantially between said first stage 24 and said second stage 25, where said holes 23 have their central axis of the lateral orifices 27 substantially perpendicular to the central longitudinal axis 90 of the respective flotation column and the pulp flow 80, and connecting said nozzle to the outside for injection of aeration pulp flow 80 by the Venturi principle. A third stage 91 comprises a first portion 91a and a second portion 91b. A first portion 91a cone-shaped tapered in the direction of pulp flow 80 and positioned at the exit of the pulp flow 80 of the second portion 25b. The lower end of said second portion 25b and the upper end portion of said first 91a the third portion 91 are identical, so that both are coupled forming an pressure vessel comprised of an acceleration system conical tapering in the flow direction of the pulp flow 80 and soon a speed reducer of the same characteristics of the second portion 25b of the second stage 25. The second portion 91b of the third stage 91 into a cylindrical shape with a diameter identical to the lower end of said first portion of the tapered cone 91a. A fourth stage 92 comprises a set of at least four air intake holes 29 arranged equidistantly around on the basis of said injection nozzle 21, integrated substantially between said second stage 91b and the respective diffuser 15 of the respective column flotation, and that said holes 29 have their central axis of the base orifices 28 substantially parallel to the central longitudinal axis 90 of the respective flotation column and the pulp flow 80 and connecting the said injection nozzle for aeration of the outer pulp flow 80 which is substantially accomplished the second pulp mixture with air by the Venturi principle. Having four-stages 24, 25, 91 and 92 and air inlet holes 29 arranged in the base and simultaneously also lateral orifices for air intake for the injection nozzle of pulp 23 of said injection nozzle of pulp 21 performs a mixture of air pulp generating micro bubbles 5 and increasing the surface tension of the hydrophobic material for collecting. Such constructive aspect of the injection nozzle of pulp in four-stages allows the performance of the automated system of froth flotation columns with aerators injection nozzles 10, as a whole and in interaction with other components of the present invention, to be greater than would be achieved if its use would make with conventional Venturis.

Alternatively, according to another embodiment of the present invention, at least one injection nozzle of pulp 21 has aeration forcibly performed by means of compressed air, such as reciprocating compressors, rotary screw or rotary vane or others usually used in flotation columns, according to the production requirements. In particular determined by the balance between the pressure losses caused by hoses/pipes, accessories and cost.

The invention also provides a flotation columns process using said automated system of froth flotation columns with aerators injection nozzles 10 which includes various steps of operating, starting with the preparation of the pulp in a proper tank of pulp conditioning 50 where the operator should place the ore pulp or the material to be floated for about 30 min before the start of the flotation process itself, so that the reagents responsible for the generation of foaming in pulp can act. Then, it actuates the first controller 40 of the first flotation column 11 as well as it actuates the feeding of the first flotation column 11 preferably by elements for conducing pulp 35 and by a first device for transferring pulp 31, which device can use a frequency inverter. It is expected that the first flotation column 11 be filled until the pulp reaches approximately 30 cm from the top end edge of the first flotation column 11 to prevent the overflow of the pulp. By receiving pulp at the top of a first flotation column 11 through a first injection nozzle of pulp 21, configured according to an of the possibilities of embodiment of the present invention, it is performed the generation of micro bubbles of air 5 that are injected into the diffuser 15 and, consequently generating a pulp flow with air bubbles 81, after reaching the bottom of said first column flotation 11. Such air micro bubbles 5 have diameters between 1 mm. to 5 mm. After this step, it actuates the second controller 41 in the second column flotation 12 as well as it actuates the second device for transferring pulp 32, said device can use a frequency inverter.

Next, waits the pulp formed by the tail of the first column flotation 11 be transferred to a second flotation column 12 by elements for conducing pulp 35 and a second device for transferring pulp 32. By receiving the flotation tailings from a first flotation column 11 carried out by the top of a second flotation column 12 through a second injection nozzle of pulp 21, wherein the pulp is mixed with air is generated micro bubbles 5 which are injected within a diffuser 15 and consequently generating a pulp flow with air bubbles 81, up to the bottom of said second flotation column 12. After filling the first flotation column 11 the operator must adjust the sensor 45 level, which is preferably a differential pressure sensor, of the first flotation column 11 up to the point for overflowing of formed foaming, intended for the area of collecting foaming (not shown in the figure).

In the same way, after filling of the second column flotation 12, the operator must adjust the level sensor 45, which is preferably a differential pressure sensor, the first flotation column 12 to the point of overflow of foam formed destined for collection area foam (not shown in the figure). In the case the level of foam is inappropriate, it should be performed an adjustment in the aeration of the columns, preferably through the air control valve 19, which can be mechanical or electronic one, in accordance with an embodiment of the present invention. Preferably, this adjustment is initiated by the first flotation column 11. If the aeration setting is insufficient for adequate flotation with generation of foam in bubble size and in suitable amounts for the overflow on area of collecting foaming (not shown in the figure), the operator should adjust the level of foam through the respective controller of the column which foam generation is insufficient. After stabilizing the process, the control should be done with the tank of pulp conditioning 50 to assure feeding of the column in sufficient volume to the required work and, also sporadically on the floated material by adjusting the column supply through the controllers, always as needed. As the material is floating, it is carried out the concentrate transfer from a first flotation column 11 to a tank of concentrates 60 through floating material outlet of the first flotation column 14 from a first flotation column 11, as well as the concentrate transfer from a second flotation column 12 to a tank of concentrates 60 is performed through floating material outlet 18 of a second flotation column 12. The step of managing the process of automated flotation columns with nozzles aerators 10 is performed with at least the controllers 40 and 41.

In a particular embodiment of the present invention, the step of transferring the flotation tailings from a second flotation column 12 is performed to at least a third flotation column (not shown), instead of transferring to the outside of the automated flotation columns with nozzles aerators 10, preferably by means of elements of conducting pulp 35 and a third device for transferring of pulp 33 and so successively, depending on the volume of material that one wishes to float. In another particular embodiment of the present invention, managing of the flotation system 10 is carried out at least by the controllers 40 and 41 wherein such control includes the steps of identifying the flow of feeding pulp, the volume of foam formed and the level of air contained in the pulp into a first flotation column 11 and into a second flotation column 12. The identification of the flow of feeding pulp is supplemented by regulating the flow of incoming and outgoing pulp from a first flotation column 11 using at least a sensor 45 on the ascent of the pulp inserted in said first flotation column 11 through the speed control from a first device for transferring pulp 31 and a second device for transferring pulp 32, both held by a frequency inverter or a device that is able to perform the same function.

Similarly, and as this is a system, the identification of pulp level and foam flotation of a first flotation column 11 is carried by the first controller 40, accomplished by positioning a sensor. To regulate the flow of incoming and outgoing of pulp from the second flotation column 12 is used at least a sensor 45 on the ascent of pulp inserted in said second flotation column 12 through control speed of a second device for transferring of pulp 32 and a third device for transferring of pulp 33, both also performed by frequency inverter or device that is able to perform the same function. For a second flotation column 12, the identification of the pulp and the level of the foam is carried by a second controller 41, accomplished by positioning a sensor, and by the control of input speed and output speed of the motors of the devices for transferring of pulp 31, 32 and 33, thus adjusting and seeking operation and performance of a first flotation column 11 and a second flotation column 12 so as to have micro bubbles 5 from 1 mm to 5 mm in diameter. Furthermore, the managing of the automated system of froth flotation columns with aerators injection nozzles 10 is supplemented by the identification and control of air flow in the pulp, through air control valves 19 into a first flotation column 11 and a second flotation column 12.

The controllers 40 and 41 of a flotation column process as described above, according to an embodiment of the present invention, can use control rules and statistical methods to perform the managing of the automated system of froth flotation columns with aerators injection nozzles 10, such as artificial neural networks, proportional integral derivative controller (PID), feedback controls systems, heuristic methods for error correction or fuzzy logic.

While exemplary embodiments have been particularly shown and described, various changes in form and details may be made therein by a person skilled in the art. Such changes and other equivalents are also intended to be encompassed by the following claims.

1. An automated system of froth flotation columns with aerators injection nozzles comprising:
at least two flotation columns interconnected to each other,
a first of the at least two flotation columns including
at least one differential pressure sensor configured with at least a sensor
at least an injection nozzle of pulp, disposed substantially at a center of the at least a diffuser top and substantially in line with a central longitudinal axis of said first flotation column and connected to respective bases of said respective nozzles at an upper end of each respective diffuser, a diameter of each respective diffuser being relatively larger than the respective diameter of the injection nozzle of pulp and relatively smaller than a vessel/recipient diameter of own flotation column, and
at least an anti-turbulence device;
a second of the at least two flotation columns including
at least a differential pressure sensor configured with at least a sensor and
at least an injection nozzle of pulp disposed substantially at a center of the at least a diffuser top and substantially in line with a central longitudinal axis of said second flotation column and connected to the respective bases of said respective nozzles at an upper end of each respective diffuser, a diameter of each respective diffuser being relatively larger than the respective diameter of the injection nozzle of pulp and relatively smaller than the vessel/recipient diameter of own flotation column, and
at least an anti-turbulence device;
at least a first transfer pulp device which interconnects one injection nozzle of pulp from the first flotation column with a tank of pulp conditioning through elements of pulp driving;
at least a second transfer pulp device which interconnects the first flotation column by the non-floating material outlet of said first flotation column with an injection nozzle of pulp of the second flotation column through elements of pulp driving;
at least one third transfer pulp device which interconnects the second flotation column by the non-floating material outlet of said second flotation column with the outside through elements of pulp driving;
at least a tank of concentrates, connected to a first flotation column by the floating concentrate material outlet through elements of pulp driving, and interconnected to the second column flotation by the floating material outlet by an element of conducting pulp;
at least a first controller, connected to a transfer pulp device and connected to the sensor in said first flotation column; and
at least a second controller, connected to a second transfer pulp device and a third transfer pulp device and connected to a sensor of said second flotation column, and so successively in accordance to the addition of flotation columns to said automated system of froth flotation columns with aerators injection nozzles.

2-6. (canceled)

7. The automated system of froth flotation columns with aerators injection nozzles of claim 1, wherein a sensor of the first flotation column is a differential pressure sensor configured with at least an ultrasound sensor.

8. The automated system of froth flotation columns with aerators injection nozzles of claim 1,—wherein a sensor of the first flotation column is a differential pressure sensor configured with at least an infrared sensor.

9. The automated system of froth flotation columns with aerators injection nozzles of claim 1,—wherein a sensor of the second flotation column is a differential pressure sensor configured with at least an ultrasound sensor.

10. The automated system of froth flotation columns with aerators injection nozzles of claim 1,—wherein a sensor of the first flotation column is a differential pressure sensor configured with at least an infrared sensor.

11-14. (canceled)

15. The automated system of froth flotation columns with aerators injection nozzles of claim 1,—wherein at least an injection nozzle of pulp has two-stages integrated, wherein:
a first of the two stages including a first portion cone-shaped tapered in the flow direction of pulp, and positioned in the pulp flow of the respective injection nozzle of pulp, and a second portion cylindrical shaped with a diameter identical to the lower end of said cone-shaped tapering of the first portion, and including one end of constriction;
a second of the two stages including a first portion cone-shaped tapered in the direction of pulp flow and positioned at the outflow of pulp flow of said first stage, where is substantially performed the mixture of the pulp with air; and
at least four lateral orifices for air intake for the injection nozzles of pulp arranged in a manner equidistant on a side, same height and around of said injection nozzle of pulp, substantially integrated between said first stage and said second stage, said at least four lateral orifices for air intake for the injection nozzles of pulp including a central axis of the lateral orifices substantially perpendicular to the central longitudinal axis of the respective flotation column and to the pulp flow and connect the said injection nozzle of pulp to the outside for aeration pulp flow by Venturi principle.

16. The automated system of froth flotation columns with aerators injection nozzles of claim 1, wherein at least an injection nozzle of pulp includes two-stages-straight integrated, wherein:
a first of the two-stages-straight integrated including a first portion cone-shaped tapered in the direction of pulp flow, and positioned in the pulp flow of the respective injection nozzle of pulp, and a second portion cylindrical shaped with a diameter identical to the lower end of said cone-shaped tapering of the first portion and including one end of constriction
a second of the two-stages-straight integrated including a first portion and a second portion cylindrical shaped with a diameter identical to the lower end of said cone-shaped tapering of the first portion of the first stage; and
at least four lateral orifices for air intake for the injection nozzles of pulp arranged in a manner equidistant a side, at same height and around of said injection nozzle of pulp substantially integrated between said first stage and said second stage said at least four lateral orifices for air intake for the injection nozzles of pulp including a central axis of the lateral orifices substantially perpendicular to the central longitudinal axis of the respective flotation column and to the pulp flow and connect the said injection nozzle of pulp to the outside for natural aeration of the pulp flow by Venturi principle.

17. The automated system of froth flotation columns with aerators injection nozzles of claim 1, further comprising:
at least an injection nozzle of pulp, including a single-stage including a first portion cone-shaped tapered in the direction of pulp flow and positioned in the inflow of pulp flow of the respective injection nozzle of pulp and a second portion cylindrical shaped with a diameter identical to the lower end of said cone-shaped tapering of the first portion and
at least four base orifices for air intake for the injection nozzles of pulp arranged in a manner equidistant around on a base of said injection nozzle of pulp substantially integrated between said single-stage and the respective diffuser of the respective flotation column, and said base orifices for air intake for the injection nozzles of pulp including a central axis of the base orifices substantially parallel to the central longitudinal axis of the respective flotation column and to the pulp flow and connect the said injection nozzle to the outside for natural aeration of the pulp flow by Venturi principle.

18. The automated system of froth flotation columns with aerators injection nozzles of claim 1, wherein at least one injection nozzle of pulp has three-stages integrated, and wherein:
a first of the three-stages integrated including a first portion cone-shaped tapered in the direction of pulp flow and positioned in the inflow of pulp flow of the respective injection nozzle of pulp and a second portion cylindrical shaped with a diameter identical to the lower end of said tapered cone-shaped the first portion and including one end of constriction
a second of the three-stages integrated including a first portion also cone-shaped tapered in the direction of pulp flow and positioned at the exit of the flow of pulp of said first stage where is substantially performed first mixture the pulp with air by Venturi principle;
at least four lateral orifices for air intake for the injection nozzles of pulp, arranged in a manner equidistant on a side, at same height and around of said injection nozzle of pulp substantially integrated between said first stage and said second stage and said lateral orifices for air intake for the injection nozzles of pulp including a central axis of the lateral orifices substantially perpendicular to the central longitudinal axis of the respective flotation column and to the pulp flow and connect the said injection nozzle of pulp to the outside for aeration of the pulp flow by Venturi principle; and
a third of the three-stages integrated including a set of at least four base orifices for air intake for the injection nozzles of pulp arranged in a manner equidistant around on the base of said injection nozzle of pulp integrated substantially between said second stage and the respective diffuser of the respective flotation column, and said air intake orifices including a central axis of the base orifices substantially parallel to the central longitudinal axis of the respective flotation column and to the pulp flow and connect said injection nozzle of pulp to the outside for natural aeration of the pulp flow where is substantially accomplished the second pulp mixture with air by Venturi principle.

19. The automated system of froth flotation columns with aerators injection nozzles of claim 1, wherein at least one injection nozzle of pulp includes four-stages integrated, wherein:
a first of the four-stages integrated including a first portion cone-shaped tapered in the direction of pulp flow and positioned in the inflow of pulp flow of the respective injection nozzle of pulp and a second portion cylindrical shaped with a diameter identical to the lower end of said tapered cone-shaped the first portion and including one end of constriction
a second of the four-stages integrated including a first portion in cylindrical shape with a diameter identical to the lower end of said cone taper of the second portion of the first stage where is substantially performed the first mixture of pulp with air by the Venturi principle, and a second portion tapering cone-shaped in contraty direction of the inflow of pulp and positioned at the exit of the flow of pulp of said first portion
at least four lateral orifices for air intake for the injection nozzles of pulp are arranged in a manner equidistant on a side, at same height and around of said injection nozzle of pulp substantially integrated between said first stage and said second stage and said lateral orifices for air intake for the injection nozzles of pulp including a central axis of the lateral orifices substantially perpendicular to the central longitudinal axis of the respective flotation column and to the pulp flow and connect the said injection nozzle of pulp to the outside for natural aeration of the pulp flow by Venturi principle;
a third of the four-stages integrated stage including a first portion cone-shaped tapered in the direction of pulp flow and positioned in the inflow of pulp flow of the second portion of the second stage and a second portion cylindrical shaped with a diameter identical to the lower end of said cone-shaped tapering of the first portion and
a fourth of the four-stages integrated including a set of at least four base orifices for air intake for the injection nozzles of pulp arranged in a manner equidistant around on the base of said injection nozzle of pulp integrated substantially between said forth stage and the respective diffuser of the respective flotation column, and said air intake orifices have their central axis of the base orifices substantially parallel to the central longitudinal axis of the respective flotation column and to the pulp flow and connect said injection nozzle of pulp to the outside for natural aeration of the pulp flow where is substantially accomplished the second pulp mixture with air by Venturi principle.

20-28. (canceled)

29. A process of flotation columns using an automated system of froth flotation columns with aerators injection nozzles, the method comprising:
conditioning pulp in a proper tank of pulp conditioning
transferring the pulp from the conditioning tank to a first flotation column by use of elements of pulp driving and a first transfer pulp device
receiving the pulp at the top of a first flotation column through a first injection nozzle of pulp said first injection nozzle of pulp where the pulp is mixed with air naturally generating air micro bubbles including diameters between 1 mm to 5 mm and are injected into the diffuser and consequently generating a pulp flow with bubbles that subsequently reach the bottom of said first column flotation
transferring the concentrate to a first flotation column to a tank of concentrates via a floating material outlet of a first flotation column
transferring the flotation tailings from a first flotation column to a second flotation column by means of elements of pulp driving and a second transfer pulp device
receiving the flotation tailings of a first flotation column at the top of a second flotation column through a second injection nozzle of pulp, wherein the pulp is mixed with air entraining naturally through the bottom of the respective injection nozzle of pulp in parallel and simultaneously to the direction of pulp flow generating air micro bubbles that are injected into a diffuser and consequently a pulp flow with air bubbles to the bottom of said second flotation column
transferring the concentrate from a second flotation column to a tank of concentrates via a floating material outlet of a second flotation column
transferring the flotation tailings from a second flotation column to the outside of the automated flotation columns with nozzles aerators by way of elements of pulp driving and a third transfer pulp device and so successively; and
managing the process of automated flotation columns with nozzles aerators with at least the controllers.

30-31. (canceled)

32. The flotation column process of claim 29, wherein the managing of the automated system of froth flotation columns with aerators injection nozzles is held in said automated system of froth flotation columns with aerators injection nozzles at least by controllers and wherein the control includes:
identifying feed stream of pulp, a volume of foam formed and a level of air contained in the pulp of a first flotation column and a second flotation column
regulating the flow of incoming and outgoing of pulp from a first flotation column using at least a sensor on an ascent of the pulp inserted in said first flotation column by the speed control a first transfer pulp device and a second transfer pulp device both carried by a frequency inverter;
identifying the level of the pulp and foam of a first flotation column by positioning a sensor carried by the first controller
regulating the flow of incoming and outgoing of pulp from the second flotation column using at least a sensor on the ascent of the pulp inserted in said second flotation column by the speed control of a second transfer pulp device and a third transfer pulp device both carried by inversion frequency;
identifying the level of the pulp and foam of a second flotation column by positioning a sensor carried by a second controller;
controlling the speed in and out of the motors of the transfer pulp device, seeking and adjusting the operation and performance of a first flotation column and a second column flotation so as to have micro bubbles of 1 mm to 5 mm diameters; and
identifying and controlling the airflow into the pulp, through air control valve in the flotation process in a first flotation column and a second flotation column.

33. The flotation column process of claim 29, wherein the managing of the automated system of froth flotation columns with aerators injection nozzles is held in said automated system of froth flotation columns with aerators injection nozzles at least by controllers and wherein the control includes: using rules and statistical methods as artificial neural networks, proportional integral derivative controller, feedback controls systems, heuristic methods for error correction or fuzzy logic, or combinations thereof.

34. The automated system of froth flotation columns with aerators injection nozzles of claim 1, wherein the at least two flotation columns are interconnected to each other in series and wherein the at least a second transfer pulp device is a motor pump.

35. The flotation column process of claim 29, wherein said second injection nozzle of pulp is configured in a single-stage.
